(19) United States
(12) Patent Application Publication
(10) Pub. No.: US 2025/0304838 A1
(43) Pub. Date: Oct. 2, 2025

(54) Aqueous Adhesive Composition

(71) Applicant: SEIKO EPSON CORPORATION, Tokyo (JP)

(72) Inventors: Harunobu KOMATSU, Matsumoto (JP); Nikako TSUKIJI, Matsumoto (JP); Soichi YAMAZAKI, Shiojiri (JP)

(21) Appl. No.: 19/092,079

(22) Filed: Mar. 27, 2025

(30) Foreign Application Priority Data
Mar. 28, 2024 (JP) 2024-053104

(51) Int. Cl. C09J 133/10; B41J 3/407; B41J 11/00; B41J 29/17; C09J 5/00; C09J 133/08

(52) U.S. Cl. CPC C09J 133/10; B41J 3/4078; B41J 11/0015; B41J 29/17; C09J 5/00; C09J 133/08; C09J 2433/00; C09J 2499/00

(57) ABSTRACT

There is provided an aqueous adhesive composition for forming an adhesive layer of a fabric transport member of an ink jet textile printing apparatus including a transport mechanism that bonds a fabric to the adhesive layer formed at a surface of the fabric transport member to transport the fabric, a heating portion that heats the adhesive layer, a bonding portion that bonds the fabric to the heated adhesive layer, a recording portion that attaches an ink composition to the fabric bonded to the adhesive layer using an ink jet head, a peeling portion that peels off the recorded fabric from the adhesive layer, and a cleaning portion that cleans the adhesive layer from which the fabric is peeled off with a cleaning solution containing water, the aqueous adhesive composition including: a (meth)acrylic resin; and water, in which when an adhesive force with which the fabric is peeled off from the adhesive layer cooled to 23° C. after bonding the fabric to the adhesive layer heated to 33° C. is represented by an adhesive force A (N/50 mm) and an adhesive force with which the fabric is peeled off from the adhesive layer at 23° C. after bonding the fabric to the adhesive layer at 23° C. is represented by an adhesive force B (N/50 mm), a change rate of adhesive force per unit temperature represented by (A−B)/(33° C.−23° C.) is 0.050 N/° C.·50 mm or more.

### AQUEOUS ADHESIVE COMPOSITION

The present application is based on, and claims priority from JP Application Serial Number 2024-053104, filed Mar. 28, 2024, the disclosure of which is hereby incorporated by reference herein in its entirety.

### BACKGROUND

### 1. Technical Field

The present disclosure relates to an aqueous adhesive composition.

### 2. Related Art

Ink jet recording methods can record high-definition images with a relatively simple apparatus and are rapidly developed in various fields. Among the fields, various studies have been conducted on discharge stability and the like. For example, JP-A-2020-200120 discloses an image recording apparatus including: an endless belt where a heat-sensitive adhesive is provided on a surface and that transports a recording medium by moving the recording medium adhered to and held by the heat-sensitive adhesive; an image forming portion that forms an image on the recording medium transported by the endless belt; a cleaning portion that is disposed downstream of the image forming portion in a transport direction of the recording medium and sprays a cleaning solution to the heat-sensitive adhesive peeled off from the recording medium to clean the heat-sensitive adhesive; a supply pipe that supplies the cleaning solution to the cleaning portion; and a cleaning solution heating portion that heats the cleaning solution supplied to the cleaning portion, in which the cleaning solution heating portion heats the supply pipe in the vicinity of the cleaning portion.

JP-A-2020-200120 discloses that the heat-sensitive adhesive is heated to improve the adhesion of the recording medium with the heat-sensitive adhesive. However, it cannot be said that the adhesive layer where the adhesion is improved by heating has sufficient durability to cleaning.

### SUMMARY

According to an aspect of the present disclosure, there is provided an aqueous adhesive composition for forming an adhesive layer of a fabric transport member of an ink jet textile printing apparatus including a transport mechanism that bonds a fabric to the adhesive layer formed at a surface of the fabric transport member to transport the fabric, a heating portion that heats the adhesive layer, a bonding portion that bonds the fabric to the heated adhesive layer, a recording portion that attaches an ink composition to the fabric bonded to the adhesive layer using an ink jet head, a peeling portion that peels off the recorded fabric from the adhesive layer, and a cleaning portion that cleans the adhesive layer from which the fabric is peeled off with a cleaning solution containing water, the aqueous adhesive composition including: a (meth)acrylic resin; and water, in which when an adhesive force with which the fabric is peeled off from the adhesive layer cooled to 23° C. after bonding the fabric to the adhesive layer heated to 33° C. is represented by an adhesive force A (N/50 mm) and an adhesive force with which the fabric is peeled off from the adhesive layer at 23° C. after bonding the fabric to the adhesive layer at 23° C. is represented by an adhesive force B (N/50 mm), a change rate of adhesive force per unit temperature represented by (A−B)/(33° C.−23° C.) is 0.050 N/° C.·50 mm or more.

According to another aspect of the present disclosure, there is provided an adhesion imparting method including: attaching the above-described aqueous adhesive composition to a surface of a fabric transport member of an ink jet textile printing apparatus to form an adhesive layer.

According to still another aspect of the present disclosure, there is provided an ink jet textile printing apparatus including: a transport mechanism that bonds a fabric to an adhesive layer of the above-described aqueous adhesive composition formed at a surface of a fabric transport member to transport the fabric; a heating portion that heats the adhesive layer, a bonding portion that bonds the fabric to the heated adhesive layer; a recording portion that attaches an ink composition to the fabric bonded to the adhesive layer using an ink jet head; a peeling portion that peels off the recorded fabric from the adhesive layer, and a cleaning portion that cleans the adhesive layer from which the fabric is peeled off with a cleaning solution containing water.

According to still another aspect of the present disclosure, there is provided a fabric transport member of an ink jet textile printing apparatus including: an adhesive layer of the above-described aqueous adhesive composition on a surface.

According to still another aspect of the present disclosure, there is provided an ink jet textile printing method including: bonding a fabric to an adhesive layer of the above-described aqueous adhesive composition formed at a surface of a fabric transport member of an ink jet textile printing apparatus to transport the fabric; heating the adhesive layer; bonding the fabric to the heated adhesive layer; attaching an ink composition to the fabric bonded to the adhesive layer using an ink jet head; peeling off the recorded fabric from the adhesive layer; and cleaning the adhesive layer from which the fabric is peeled off with a cleaning solution containing water.

### BRIEF DESCRIPTION OF THE DRAWINGS

FIG. 1 is a schematic cross-sectional view illustrating an ink jet textile printing apparatus.

FIG. 2 is a table illustrating a configuration of a (meth)acrylic resin.

FIG. 3 is a table illustrating Examples and Comparative Examples.

### DESCRIPTION OF EMBODIMENTS

Hereinafter, an embodiment of the present disclosure (hereinafter referred to as “the present embodiment”) is described in detail with reference to the drawings. However, the present disclosure is not limited to the embodiment and can be variously modified without deviating from the scope of the present disclosure as described in the claims. In the drawings, the same components are designated by the same reference numerals and the same description will be omitted. The positional relationship, such as left, right, top, and bottom, should be based on the positional relationship illustrated in the drawings unless otherwise particularly specified. Furthermore, the dimensional ratios in the drawings are not limited to the ratios illustrated in the drawings.

“(Meth)acrylate” refers to a generic expression including an acrylate and a methacrylate. In addition, “unit” such as “constituent unit” or “(meth)acrylate unit” refers to a repeating unit derived from a monomer when the monomer is polymerized into a polymer.

### 1. Aqueous Adhesive Composition

According to the present embodiment, there is provided an aqueous adhesive composition for forming an adhesive layer of a fabric transport member of an ink jet textile printing apparatus including a transport mechanism that bonds a fabric to the adhesive layer formed at a surface of the fabric transport member to transport the fabric, a heating portion that heats the adhesive layer, a bonding portion that bonds the fabric to the heated adhesive layer, a recording portion that attaches an ink composition to the fabric bonded to the adhesive layer using an ink jet head, a peeling portion that peels off the recorded fabric from the adhesive layer, and a cleaning portion that cleans the adhesive layer from which the fabric is peeled off with a cleaning solution containing water, the aqueous adhesive composition including: a (meth)acrylic resin; and water, in which when an adhesive force with which the fabric is peeled off from the adhesive layer cooled to 23° C. after bonding the fabric to the adhesive layer heated to 33° C. is represented by an adhesive force A (N/50 mm) and an adhesive force with which the fabric is peeled off from the adhesive layer at 23° C. after bonding the fabric to the adhesive layer at 23° C. is represented by an adhesive force B (N/50 mm), a change rate of adhesive force per unit temperature represented by (A−B)/(33° C.−23° C.) is 0.050 N/° C.·50 mm or more.

The aqueous adhesive composition according to the present embodiment is a composition that is applied to the fabric transport member and dried to form an adhesive layer. With the above-described configuration, the adhesive force of the adhesive layer and the durability for suppressing a decrease in adhesive force during brushing can be simultaneously achieved. Hereinafter, each of the components in the aqueous adhesive composition will be described in detail.

### 1.1. Adhesive Force Characteristics

In the present embodiment, an adhesive force with which the fabric is peeled off from the adhesive layer cooled to 23° C. after bonding the fabric to the adhesive layer heated to 33° C. is represented by “adhesive force A (N/50 mm)”, and an adhesive force with which the fabric is peeled off from the adhesive layer at 23° C. after bonding the fabric to the adhesive layer at 23° C. is represented by “adhesive force B (N/50 mm)”.

At this time, the change rate of adhesive force per unit temperature represented by (A−B)/(33° C.−23° C.) in the aqueous adhesive composition is 0.050 N/° C.·50 mm or more and is preferably 0.055 to 0.300 N/° C.·50 mm, 0.058 to 0.250 N/° C.·50 mm, 0.060 to 0.200 N/° C.·50 mm, or 0.63 to 0.150 N/° C.·50 mm. By adjusting the change rate of adhesive force per unit temperature to be 0.050 N/° C.·50 mm or more, the adhesive force and the durability of the adhesive layer tend to be further improved.

The adhesive force B is preferably 0.1 to 4.0 N/50 mm, 0.2 to 3.0 N/50 mm, 0.3 to 2.5 N/50 mm, or 0.5 to 2.0 N/50 mm. By adjusting the adhesive force A to be in the above-described range, the adhesive force and the durability of the adhesive layer tend to be further improved.

The adhesive force A is preferably 0.1 to 5.0 N/50 mm, 0.2 to 4.5 N/50 mm, 0.3 to 4.0 N/50 mm, 0.5 to 3.5 N/50 mm, 1.0 to 3.0 N/50 mm, or 1.5 to 3.0 N/50 mm. By adjusting the adhesive force B to be in the above-described range, the adhesive force and the durability of the adhesive layer tend to be further improved.

The adhesive forces A and B and the change rate of adhesive force per unit temperature can be adjusted depending on a glass transition temperature of the (meth)acrylic resin to be used or, when a plurality of (meth)acrylic resins are used, depending on contents or compositions of the (meth)acrylic resins.

By applying and drying the aqueous adhesive composition, formation conditions of the adhesive layer used for defining the adhesive force characteristics and viscoelasticity characteristics are as follows. First, the aqueous adhesive composition is applied to a glass substrate such that the thickness of the adhesive layer is 200 μm, is dried at 23° C. without air circulation, and is dried in a thermostatic bath at 50° C. for 30 minutes to form the adhesive layer. In the adhesive force measurement, Italian cotton having a width of 50 mm is bonded to the adhesive layer formed as described above under a load of 1.0 kgf/50 mm to measure a degree peel force. At this time, a temperature during the bonding and a temperature during the peeling conform to the definitions of the adhesive forces A and B.

### 1.2. Viscoelasticity Characteristics

In the adhesive layer formed of the aqueous adhesive composition, a difference (G″23−G″33) between a loss elastic modulus G″23 at 23° C. and a loss elastic modulus G″33 at 33° C. is preferably 1×10³ to 15×10³ Pa, 2×10³ to 12.5×10³ Pa, 3×10³ to 10×10³ Pa, or 4×10³ to 9×10³ Pa. By adjusting the difference (G″23-G″33) to be in the above-described range, the adhesive force and the durability of the adhesive layer tend to be further improved.

In the adhesive layer formed of the aqueous adhesive composition, the loss elastic modulus G″23 at 23° C. is preferably 5.0×10³ to 75×10³ Pa, 7.5×10³ to 50×10³ Pa, or 10×10³ to 35×10³ Pa. The loss elastic modulus G″23 is preferably more than the loss elastic modulus G″33. By adjusting the loss elastic modulus G″23 to be in the above-described range, the adhesive force and the durability of the adhesive layer tend to be further improved.

In the adhesive layer formed of the aqueous adhesive composition, the loss elastic modulus G″33 at 33° C. is preferably 2.5×10³ to 50×10³ Pa, 5.0×10³ to 35×10³ Pa, or 7.5×10³ to 25×10³ Pa. By adjusting the loss elastic modulus G″33 to be in the above-described range, the adhesive force and the durability of the adhesive layer tend to be further improved.

The viscoelasticity characteristics G″23 and G″33 and the difference (G″23−G″33) therebetween can be adjusted depending on a constituent unit of the (meth)acrylic resin to be used or, when a plurality of (meth)acrylic resins are used, depending on contents or compositions of the (meth)acrylic resins.

### 1.3. (Meth)Acrylic Resin

By including the (meth)acrylic resin, the adhesive force and the durability of the adhesive layer formed at the fabric transport member are further improved. The (meth)acrylic resin may be a water-soluble resin or may be a resin emulsion dispersed in an aqueous solvent. The water-soluble resin and the resin emulsion will also be generically referred to the (meth)acrylic resin in the present embodiment. In addition, the (meth)acrylic resin may be obtained by copolymerization of an allyl monomer in addition to a (meth)acrylate.

The (meth)acrylic resin is not particularly limited as long as it is a polymer obtained by polymerization of a (meth)acrylic monomer such as (meth)acrylic resin or a (meth)acrylic acid ester as one component, and examples of the (meth)acrylic resin include a homopolymer obtained from a (meth)acrylic monomer and a copolymer of a (meth)acrylic monomer and another monomer. More specifically, the (meth)acrylic monomer is not particularly limited, and examples thereof include: a (meth)acrylic monomer having an aliphatic group such as methyl methacrylate (MMA), ethyl methacrylate (EMA), butyl methacrylate (BMA), butyl acrylate (BA), or 2-ethylhexyl acrylate (2EHA); and a (meth)acrylic monomers having an aromatic group such as styrene (St). The other monomers are not particularly limited, and examples thereof include acrylamide and acrylonitrile.

In the aqueous adhesive composition, the (meth)acrylic resin may include a first (meth)acrylic resin including, as a constituent unit, a (meth)acrylic monomer where a glass transition temperature of a homopolymer is 40° C. or higher, or may include a second (meth)acrylic resin having a higher glass transition temperature Tg2 than a glass transition temperature Tg1 of a first (meth)acrylic resin. By further including the first (meth)acrylic resin and the second (meth)acrylic resin having different glass transition temperatures Tg, the adhesive force and the effect of suppressing a decrease in adhesive force during brushing tend to be further improved.

The glass transition temperature Tg1 of the first (meth)acrylic resin is preferably −70 to −15° C., −65 to −20° C., −60 to −25° C., or −55 to −30° C. By adjusting the glass transition temperature Tg1 to be in the above-described range, a decrease in adhesive force during brushing tends to be further suppressed.

The glass transition temperature Tg2 of the second (meth)acrylic resin is preferably −30 to −5° C., −25 to −0° C., −20 to −2.5° C., or −15 to −5° C. By adjusting the glass transition temperature Tg2 to be in the above-described range, the adhesive force tends to be further improved.

A difference |Tg1−Tg2| between the glass transition temperature Tg1 and the glass transition temperature Tg2 is preferably 10 to 50° C., 15 to 45° C., 20 to 40° C., or 25 to 35° C. By adjusting the difference |Tg1−Tg2| to be in the above-described range, the adhesive force and the effect of suppressing a decrease in adhesive force during brushing tend to be further improved.

In the present embodiment, the glass transition temperature can be measured by differential scanning calorimetry (DSC) using a well-known method of the related art. In addition, the glass transition temperature of the (meth)acrylic resin can be adjusted based on a glass transition temperature of a homopolymer of a polymerizable compound to be used and a content mass ratio of a polymerizable compound to be used.

The monomer in the first (meth)acrylic resin is not particularly limited, and preferable examples thereof include a (meth)acrylic monomer having at least an aliphatic group such as ethyl methacrylate, butyl methacrylate, butyl acrylate, or 2-ethylhexyl acrylate. By using the first (meth)acrylic resin including the above-described monomer, the adhesive force and the effect of suppressing a decrease in adhesive force during brushing tend to be further improved.

It is preferable that the first (meth)acrylic resin includes, as a constituent unit, a (meth)acrylic monomer where a glass transition temperature of a homopolymer is 40° C. or higher. Since the first (meth)acrylic resin includes the above-described monomer, the adhesive force of the adhesive layer and the effect of suppressing a decrease in adhesive force during brushing tend to be further improved.

The content of the (meth)acrylic monomer where a glass transition temperature of a homopolymer is 40° C. or higher is preferably 25 to 55% by mass, 30 to 50% by mass, or to 45% by mass with respect to the total amount of the first (meth)acrylic resin. By adjusting the content of the (meth)acrylic monomer where a glass transition temperature of a homopolymer is 40° C. or higher to be in the above-described range, the adhesive force of the adhesive layer and the effect of suppressing a decrease in adhesive force during brushing tend to be further improved.

The monomer in the second (meth)acrylic resin is not particularly limited, examples thereof are as described above, and preferable examples thereof include a (meth)acrylic monomer having at least an aliphatic group such as ethyl methacrylate, butyl methacrylate, butyl acrylate, or 2-ethylhexyl acrylate. By using the second (meth)acrylic resin including the above-described monomer, the adhesive force and the effect of suppressing a decrease in adhesive force during brushing tend to be further improved.

The content of the (meth)acrylic monomer where a glass transition temperature of a homopolymer is 40° C. or higher is preferably 2.5 to 20% by mass, 5.0 to 15% by mass, or 7.5 to 10% by mass with respect to the total amount of the second (meth)acrylic resin. By adjusting the content of the (meth)acrylic monomer where a glass transition temperature of a homopolymer is 40° C. or higher to be in the above-described range, the adhesive force of the adhesive layer and the effect of suppressing a decrease in adhesive force during brushing tend to be further improved.

The content of the first (meth)acrylic resin is preferably 50 to 85% by mass, 53 to 82% by mass, 55 to 75% by mass, or 60 to 70% by mass with respect to the total amount of the first (meth)acrylic resin and the second (meth)acrylic resin. By adjusting the content of the first (meth)acrylic resin to be in the above-described range, the adhesive force of the adhesive layer and the effect of suppressing a decrease in adhesive force during brushing tend to be further improved.

The content of the second (meth)acrylic resin is preferably 15 to 50% by mass, 18 to 47% by mass, 25 to 45% by mass, or 30 to 40% by mass with respect to the total amount of the first (meth)acrylic resin and the second (meth)acrylic resin. By adjusting the content of the second (meth)acrylic resin to be in the above-described range, the adhesive force of the adhesive layer and the effect of suppressing a decrease in adhesive force during brushing tend to be further improved.

The content of the (meth)acrylic resin is preferably to 100% by mass, 80 to 99% by mass, or 90 to 98% by mass with respect to the total amount of the aqueous adhesive composition. By adjusting the content of the (meth)acrylic resin to be in the above-described range, the adhesive force or the durability of the obtained adhesive layer tends to be further improved. The content with respect to the total amount of the aqueous adhesive composition refers to the amount of solid content.

### 1.2. pH Adjuster

The pH adjuster is not particularly limited, but examples thereof include an inorganic acid (for example, sulfuric acid, hydrochloric acid, or nitric acid), an inorganic base (for example, lithium hydroxide, sodium hydroxide, potassium hydroxide, ammonia, or an ammonium salt), an organic base (triethanolamine, diethanolamine, monoethanolamine, or tripropanolamine), and an organic acid (for example, adipic acid, citric acid, or succinic acid).

In particular, ammonia or an ammonium salt is preferable. By using the above-described pH adjuster, when the adhesive layer is formed of the aqueous adhesive composition, ammonia is volatilized and the (meth)acrylic resins are attached to each other to form a coating film into which water is not likely to penetrate. Therefore, the durability of the adhesive force of the adhesive layer formed at the fabric transport member or the water resistance is improved, and the adhesion in a wide temperature range tends to be further maintained.

The content of the pH adjuster is preferably 0.01 to 1.50% by mass, 0.02 to 1.00% by mass, 0.03 to 0.50% by mass, or 0.04 to 0.30% by mass with respect to the total amount of the aqueous adhesive composition. By adjusting the content of the pH adjuster to be in the above-described range, the peelability, adhesion, and cleaning resistance of the adhesive layer tend to be further improved.

### 1.3. Water

In order to form the adhesive layer that is the aqueous adhesive composition, the aqueous adhesive composition may be used. The content of water in the aqueous adhesive composition is preferably 30 to 80% by mass, 35 to 70% by mass, or 40 to 60% by mass with respect to the total amount of the aqueous adhesive composition. In addition, by drying the aqueous adhesive composition under conditions of, for example, a humidity of 25%, 50° C., and 30 minutes, the adhesive layer can be formed. At this time, the content of water may be 8% by mass or less, 4% by mass or less, or 2% by mass or less.

### 1.4. Surfactant

The aqueous adhesive composition may include a surfactant. The surfactant is not particularly limited, and examples thereof include an anionic surfactant, a nonionic surfactant, and a cationic surfactant.

Examples of the anionic surfactant include an alkyl sulfate such as alkyl sulfocarboxylate, alkyl diphenyl ether disulfonate, α-olefin sulfonate, polyoxyethylene alkyl ether acetate, N-acylamino acid and a salt thereof, an N-acylmethyl taurine salt, ammonium lauryl sulfate, or sodium lauryl sulfate, alkyl sulfate polyoxyalkyl ether sulfate, alkyl sulfate polyoxyethylene alkyl ether phosphate, rosin acid soap, castor oil sulfate ester, lauryl alcohol sulfate ester, alkylphenol type phosphate ester, alkyl type phosphate ester, alkylaryl sulfonate, diethyl sulfosuccinate, diethyl hexyl sulfosuccinate, and dioctyl sulfosuccinate.

Examples of the nonionic surfactant include an acetylene glycol-based surfactant, a silicone-based surfactant, polyoxyethylene alkyl ether, polyoxyethylene alkyl phenyl ether, polyoxyethylene fatty acid ester, polyoxyethylene hardened castor oil, propylene glycol fatty acid ester, glycerin fatty acid ester, polyglycerin fatty acid ester, sorbitan fatty acid ester, sucrose fatty acid ester, alkyl polyglycoside, alkyl diethanolamide, and alkyl amine oxide.

Examples of the cationic surfactant include alkylamine salts, fatty acid amidoamine salts, monoalkyl quaternary ammonium salts, dialkyl quaternary ammonium salts, trialkyl quaternary ammonium salts, benzalkonium quaternary ammonium salts, benzetonium chloride, and alkylpyridinium salts.

In the present embodiment, the nonionic surfactant is preferable among these. More specifically, an alkyl ether-based nonionic surfactant is preferable. By using the surfactant, the durability or the water resistance tends to be maintained.

The content of the surfactant is preferably 0.1 to 4% by mass, 0.3 to 3% by mass, or 0.5 to 2% by mass with respect to 100% by mass of the (meth)acrylic resin.

### 1.5. Adhesion Imparting Agent

It is preferable that the aqueous adhesive composition does not include an adhesion imparting agent or includes a small amount of an adhesion imparting agent. When the aqueous adhesive composition does not include an adhesion imparting agent or includes a small amount of an adhesion imparting agent, the adhesive force of the adhesive layer and the effect of suppressing a decrease in adhesive force during brushing tend to be maintained. Representative examples of the adhesion imparting agent include a rosin-based compound, a terpene-based compound, and a hydrocarbon resin. More specific examples of the adhesion imparting agent include: a rosin-based compound such as natural rosin, a modified rosin, a glycerol ester of natural rosin, a glycerol ester of modified rosin, a pentaerythritol ester of natural rosin, or a pentaerythritol ester of modified rosin; a terpene-based compound such as a copolymer of natural terpene, a three-dimensional polymer of natural terpene, an aromatic modified terpene resin, a hydrogenated derivative of an aromatic modified terpene resin, a terpene phenol resin, or a terpene resin (monoterpene, diterpene, triterpene, polypentene, and the like); and a hydrocarbon resin such as an aliphatic petroleum hydrocarbon resin (C5 resin), a hydrogenated derivative of the aliphatic petroleum hydrocarbon resin, an aromatic petroleum hydrocarbon resin (C9 resin) such as a styrene oligomer, or a hydrogenated derivative of the aromatic petroleum hydrocarbon resin.

It is preferable that the aqueous adhesive composition does not include the adhesion imparting agent. However, when the aqueous adhesive composition includes the adhesion imparting agent, the content of the adhesion imparting agent is preferably 5.0% by mass or less, 4.0% by mass or less, 3.0% by mass or less, 2.0% by mass or less, or 1.0% by mass or less with respect to the total amount of the aqueous adhesive composition. By adjusting the content of the adhesion imparting agent to be in the above-described range, the adhesive force of the obtained adhesive layer and the effect of suppressing a decrease in adhesive force during brushing tend to be maintained. From the same viewpoint, the total content of compounds selected from the group consisting of the rosin-based compound, the terpene-based compound, and the hydrocarbon resin is preferably in the same range as described above.

The content of the adhesion imparting agent with respect to the total amount of the adhesive layer described below is preferably 5.0% by mass or less, 4.0% by mass or less, 3.0% by mass or less, 2.0% by mass or less, or 1.0% by mass or less.

### 1.6. Organic Solvent

From the viewpoint of reducing the environmental burden or the effect on a human body, it is preferable that the aqueous adhesive composition according to the present embodiment does not include an organic solvent. In addition, when the aqueous adhesive composition includes the organic solvent, the content of the organic solvent is preferably 5.0% by mass or less, 2.5% by mass or less, 1.0% by mass or less, 0.6% by mass or less, or 0.2% by mass or less with respect to the total amount of the aqueous adhesive composition. As a result, the environmental burden can be reduced, the amount of VOC (volatile organic compounds) during the use of the aqueous adhesive composition can be reduced, and thus the work environment tends to be further improved.

The content of the organic solvent with respect to the total amount of the adhesive layer described below is preferably 5.0% by mass or less, 2.5% by mass or less, 1.0% by mass or less, 0.6% by mass or less, or 0.2% by mass or less.

### 1.7. Color Material

It is preferable that the aqueous adhesive composition according to the present embodiment does not include a color material. In addition, when the aqueous adhesive composition includes the color material, the content of the color material is preferably 1.0% by mass or less, 0.5% by mass or less, or 0.3% by mass or less with respect to the total amount of the aqueous adhesive composition. As a result, the aqueous adhesive composition according to the present embodiment is clearly distinguished from a coloring composition such as an ink composition, a printing paste, or a coating material.

The content of the color material with respect to the total amount of the adhesive layer described below is preferably 1.0% by mass or less, 0.5% by mass or less, or 0.3% by mass or less.

### 2. Adhesive Layer

The adhesive layer may have the same composition as that of the aqueous adhesive composition, except that it is the dried aqueous adhesive composition and is different from the aqueous adhesive composition in the water content in the dry matter. The water content in the adhesive layer is preferably 8% by mass or less, 4% by mass or less, or 2% by mass or less as described above.

In addition, when the aqueous adhesive composition includes a volatile component other than water, the adhesive layer and the aqueous adhesive composition may be different in the composition of the dry matter. Specifically, when ammonia is used as the pH adjuster, the amount of the pH adjuster remaining in the adhesive layer may be less than that in the aqueous adhesive composition.

In addition, the adhesive layer may have the adhesive force characteristics and the viscoelasticity characteristics described above regarding the aqueous adhesive composition.

### 3. Adhesion Imparting Method

An adhesion imparting method according to the present embodiment includes attaching the above-described aqueous adhesive composition to a surface of a fabric transport member of an ink jet textile printing apparatus to form an adhesive layer.

The step of forming the adhesive layer is a step of attaching the above-described aqueous adhesive composition to a surface of a fabric transport member to form an adhesive layer. A method of attaching the aqueous adhesive composition to the fabric transport member is not particularly limited. The aqueous adhesive composition may be uniformly applied to the entire surface of the fabric transport member using a blade or the like, or may be applied to a part of the surface of the fabric transport member in a predetermined pattern.

In addition, in the adhesive layer forming step, the aqueous adhesive composition may be dried to form an adhesive layer. The drying temperature is preferably 10 to 60° C. or 20 to 40° C. In addition, the drying time is preferably 1 to 24 hours or 2 to 8 hours. As a result, the water resistance and the mechanical strength of the obtained adhesive layer tends to be further improved.

### 4. Ink Jet Textile Printing Apparatus

An ink jet textile printing apparatus according to the present embodiment includes: a transport mechanism that bonds a fabric to an adhesive layer of the above-described aqueous adhesive composition formed at a surface of a fabric transport member to transport the fabric; a heating portion that heats the adhesive layer; a bonding portion that bonds the fabric to the heated adhesive layer; a recording portion that attaches an ink composition to the fabric bonded to the adhesive layer using an ink jet head; a peeling portion that peels off the recorded fabric from the adhesive layer; and a cleaning portion that cleans the adhesive layer from which the fabric is peeled off with a cleaning solution containing water.

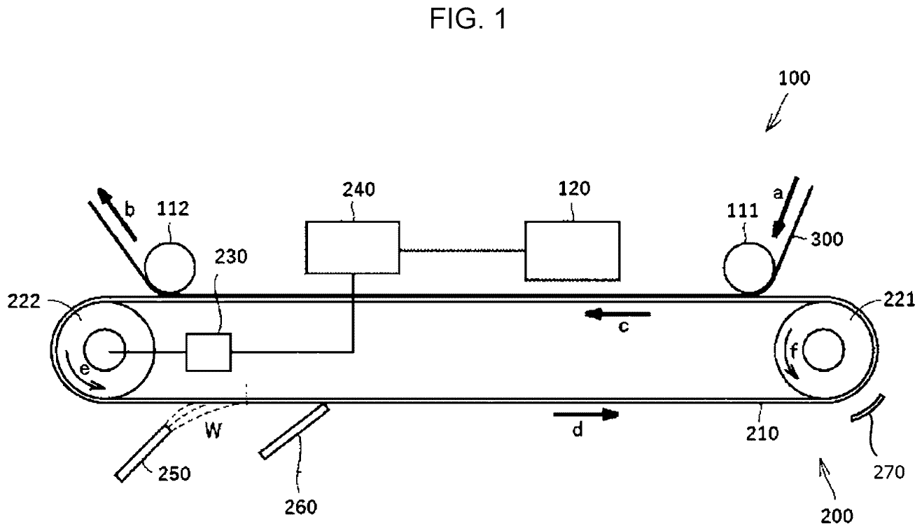

An ink jet textile printing apparatus 100 according to the present embodiment will be described with reference to FIG. 1. FIG. 1 is an overall configuration diagram illustrating the ink jet textile printing apparatus 100 including a transport device 200 according to the present embodiment. In FIG. 1, arrows a and b indicate a transport direction of a recording medium 300. Arrows c and d indicate a rotation direction of a fabric transport member 210. Arrows e and f indicate a rotation direction of transport rollers 221 and 222.

The ink jet textile printing apparatus 100 may include the transport device 200 for bonding the recording medium to the surface to transport the recording medium, recording medium transport rollers 111 and 112, and a recording portion 120. The recording medium 300 transported from the direction a is pressed against the fabric transport member 210 by the recording medium transport roller 111 (bonding portion) to bond the recording medium 300 to the surface of the fabric transport member 210.

In a state where the recording medium 300 is bonded to the surface of the fabric transport member 210, the recording medium 300 is transported to a region immediately below the recording portion 120 by the transport device 200 such that the recording medium 300 is recorded by the recording portion 120. Next, in the recording medium transport roller 112 (peeling portion), the fabric transport member 210 and the recording medium 300 are peeled off from each other.

The recording portion 120 may discharge the ink composition or the like using an ink jet method. In the present embodiment, it is assumed that the recording portion performs textile printing on textile fabric as the recording medium 300 using an ink jet head, but the present disclosure is not limited thereto.

The transport device 200 may include a pair of transport rollers 221 and 222, the fabric transport member 210, a drive motor 230, a control device 240, a cleaning portion 250, a removal member 260, and a heating portion 270.

The transport rollers 221 and 222 are rollers for transporting the fabric transport member 210 in a given direction. In addition, the fabric transport member 210 may be a belt member including the adhesive layer on the surface, or is provided around the transport rollers 221 and 222. The fabric transport member 210 transports the recording medium in the arrow c direction when the drive motor 230 rotates the transport rollers 221 and 222. The control device 240 may control either or both of the transport device 200 and the ink jet textile printing apparatus 100.

The cleaning portion 250 cleans the surface of the fabric transport member 210 from which the recording medium is peeled off. The cleaning portion 250 cleans the component of the recording medium 300 and a colorant for printing attached to the fabric transport member 210 during printing. The cleaning portion 250 may include a pump (not illustrated), a water spray port, and a water spray pipe.

The removal member 260 removes water attached to the fabric transport member 210 by the cleaning portion 250. The removal member 260 is not particularly limited, and examples thereof include a blade. As a material of the blade, an elastic material is preferable. Further, from the viewpoint of wear resistance, polyurethane is preferable. A contact portion with the fabric transport member 210 may have a rectangular shape in cross-section or may have a shape where a tip is obliquely cut.

The heating portion 270 may be provided downstream of the cleaning portion 250 and upstream of the recording medium transport roller 111 where the bonding is performed. By heating the adhesive layer with the heating portion 270, the (meth)acrylic resin forming the adhesive layer is softened, and the adhesive force tends to be further improved.

As the fabric transport member 210, an elastic material is preferable. A heater (not illustrated) for heating the fabric transport member 210 may be provided. In the step of cleaning the fabric transport member 210, a bucket portion (not illustrated) for receiving cleaning water, a brush (not illustrated) for cleaning the fabric transport member 210, a sponge (not illustrated), or the like may be used.

Examples of the recording medium 300 include a fabric formed of a natural fiber or a synthetic fiber, for example, silk, cotton, wool, nylon, polyester, or rayon. In addition, the fabric may be woven fabric, knitted fabric, non-woven fabric, or the like.

### 4. Fabric Transport Member of Ink Jet Textile Printing Apparatus

The fabric transport member of the ink jet textile printing apparatus according to the present embodiment includes an adhesive layer derived from the above-described aqueous adhesive composition on the surface. The fabric transport member is not particularly limited. For example, an elastic material is preferable, and a material including an urethane resin is more preferable. By using the above-described aqueous adhesive composition in the fabric transport member, the adhesion between the adhesive layer and the fabric transport member is further improved, and the water resistance is improved.

### 5. Ink Jet Textile Printing Method

An ink jet textile printing method includes: bonding a fabric to an adhesive layer of the above-described aqueous adhesive composition formed at a surface of a fabric transport member of an ink jet textile printing apparatus to transport the fabric; heating the adhesive layer; bonding the fabric to the heated adhesive layer; attaching an ink composition to the fabric bonded to the adhesive layer using an ink jet head; peeling off the recorded fabric from the adhesive layer; and cleaning the adhesive layer from which the fabric is peeled off with a cleaning solution containing water.

### 5.1. Heating Step

The heating step is a step of heating the adhesive layer. In the step, the adhesive layer is softened in the recording and the adhesive force is further improved. For example, in order to avoid a decrease in adhesive force caused by brushing, the adhesive layer having improved cleaning resistance is assumed. In the adhesive layer, the adhesion is also generally low, and the fixing strength of the fabric tends to be weak. Here, by providing the heating step such that the adhesive layer is temporarily softened to improve the adhesion, subsequently the adhesive layer can be bonded and transported. As a result, the fabric can be firmly fixed during recording, and the adhesive force is not likely to be generated even during cleaning.

When the fabric is bonded, the temperature of the adhesive layer is preferably 30 to 60° C. and 35 to 50° C. By adjusting the temperature of the adhesive layer to be in the above-described range, the adhesive force tends to be further improved.

### 5.2. Transport Step

The transport step is a step of bonding the fabric to an adhesive layer of the above-described aqueous adhesive composition formed at a surface of a fabric transport member of an ink jet textile printing apparatus to transport the fabric. The bonding method is not particularly limited, and examples thereof include a bonding method of pressing both of the fabric and the adhesive layer using a transport roll as illustrated in FIG. 1.

### 5.3. Recording Step

The recording step is a step of performing textile printing recording on the fabric bonded to the adhesive layer using an ink jet head. In the recording step, in a state where the fabric transport member and the fabric adhere to each other through the adhesive layer of the surface of the fabric transport member, the fabric is transported, and ink is discharged from the recording portion 120 and is attached to the fabric in the process of the transport. Next, the fabric to which the ink is attached may be peeled off and recovered from the adhesive layer.

The temperature of the adhesive layer during the peeling is preferably 10 to 30° C. or 15 to 25° C. By adjusting the temperature of the adhesive layer to be in the above-described range, the peelability tends to be further improved.

### 5.4. Cleaning Step

The cleaning step is a step of cleaning the adhesive layer from which the fabric is peeled off after the textile printing recording. In the step, dust such as waste thread derived from the attached fabric in the recording step can be removed from the adhesive layer surface.

The temperature of the adhesive layer during the cleaning is preferably 5 to 25° C. or 10 to 23° C. By adjusting the temperature of the adhesive layer to be in the above-described range, a decrease in adhesion during the cleaning tends to be further suppressed.

Further, a difference between the temperature of the adhesive layer during the bonding and the temperature of the adhesive layer during the cleaning is preferably 10° C. or higher or 15° C. or higher. As a result, a high adhesive force during the bonding is maintained, and a decrease in adhesion caused by the cleaning tends to be further suppressed.

### EXAMPLES

Hereinafter, the present disclosure will be described in more detail with reference to Examples and Comparative Examples. The present disclosure is not limited by the following Examples.

### 1. Manufacturing of Aqueous Adhesive Composition

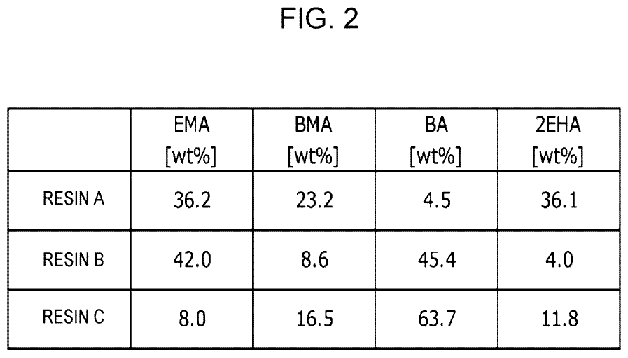

114 g of ion exchange water was added to a reactor including a stirrer, a reflux cooling tube, a thermometer, a nitrogen introduction tube, and a dropping funnel, and was heated to 82° C. Next, 497 g in total of a monomer, 118 g of ion exchange water, and 13 g of HITENOL NF-08 (polyoxyethylene styrenated phenyl ether sulfuric ammonium salt, a nonionic surfactant, manufactured by DKS Co. Ltd.) weighed to have a composition ratio shown in FIG. 2 were added, mixed, and stirred. 248 g of a 2% by mass aqueous solution of ammonium persulfate as a polymerization initiator was charged into the uniform solution at 82° C. for 1.5 hours.

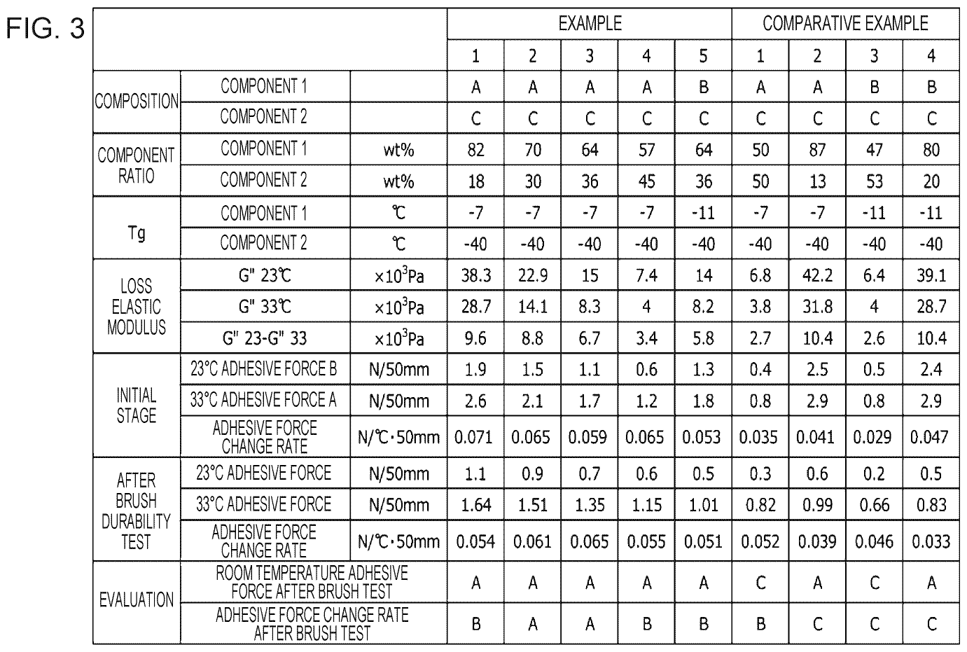

All kinds of the components described above were charged, the solution was cooled after keeping the temperature for 1 hour, ion exchange water was added, and ammonia water as a pH adjuster was charged. Next, by removing coarse particles filtered through a 150 mesh nylon filter, an aqueous adhesive composition (solid content: 50.5% by mass) including a (meth)acrylic resin having a composition illustrated in FIG. 3 was obtained. The amount of each of the monomers used in FIG. is represented by % by mass.

### 1.1. Monomer

Each of the monomers regarding the constituent units of the (meth)acrylic resins illustrated in FIG. 2 is as follows. Values in parentheses are glass transition temperatures of homopolymers.
EMA ethyl methacrylate (65° C.)
BMA butyl methacrylate (20° C.)
BA butyl acrylate (−55° C.)
2EHA: 2-ethylhexyl acrylate (−70° C.)

### 1.2. Measurement Method

### 1.2.1. Loss Elastic Modulus

The aqueous adhesive composition was applied to a glass substrate such that the thickness of the adhesive layer was 200 μm, and was dried. The loss elastic modulus of the adhesive layer prepared as described above was measured under the following conditions using a viscoelasticity measuring device (manufactured by Anton Paar GmbH, MCR302).
Parallel plate diameter: φ 8 mm
Gap range: about 0.6 to 1.0 mm
Frequency: 1.0 Hz
Strain: 0.2%
Temperature: −20° C. to 80° C.

### 1.2.2. Adhesive Force

The aqueous adhesive composition was applied to a glass substrate such that the thickness of the adhesive layer was 200 μm, and was dried. A 90 degree peel force with which cotton having a width of 50 mm was bonded to the prepared adhesive layer was measured as the adhesive force. Specifically, an adhesive force with which the fabric was peeled off from the adhesive layer cooled to 23° C. after bonding the fabric at 1.0 kgf/50 mm to the adhesive layer heated to 33° C. is represented by “adhesive force A (N/50 mm)”, and an adhesive force with which the fabric was peeled off from the adhesive layer at 23° C. after bonding the fabric at 1.0 kgf/50 mm to the adhesive layer at 23° C. is represented by “adhesive force B (N/50 mm)”.

### 1.2.3. Glass Transition Temperature

The Glass transition temperature Tg was measured according to JIS K 7121, and a value obtained by the measurement using a differential scanning calorimeter “DSC8000” (manufactured by Perkin Elmer Inc.) was shown.

### 2. Evaluation Method

### 2.1. Brush Durability Test

The aqueous adhesive composition was applied to a glass substrate such that the thickness of the adhesive layer was 200 μm, and was dried. The adhesive layer prepared as described was wetted with water using a roller-shaped nylon brush that was rotating, and was pressed to perform a durability test.

As the nylon brush, a brush where 6·10 nylon having a bristle length of 50 mm and a bristle diameter of 0.5 mm was implanted in a stainless steel cylinder having a diameter of 200 mm was used. In a state where the nylon brush was pressed against the adhesive layer at 1.0 N/cm, the nylon brush was rotated at a rotation speed of 6 rpm, and this state was maintained at room temperature for 30 days (brush durability test). 30 days after rotating the nylon brush in a state where the nylon brush was pressed against the adhesive layer, the adhesive force was measured.

Regarding the adhesive force after the brush durability test, a 180 degree peel force with which cotton having a width of 50 mm was bonded was measured as the adhesive force. Specifically, an adhesive force with which the fabric was peeled off from the adhesive layer cooled to 23° C. after bonding the fabric to the adhesive layer heated to 33° C. was measured as the adhesive force A (N/50 mm), and an adhesive force with which the fabric was peeled off from the adhesive layer at 23° C. after bonding the fabric to the adhesive layer at 23° C. was measured as the adhesive force B (N/50 mm).

After the brush durability test, an adhesive force (room temperature adhesive force) with which the fabric was peeled off from the adhesive layer at 23° C. after bonding the fabric to the adhesive layer at 23° C. was evaluated based on the following evaluation standards.

### Evaluation Standards

A: 0.4 N/50 mm or more
C: less than 0.4 N/50 mm

In addition, a change rate of adhesive force after the brush durability test was evaluated based on the evaluation standards.

### Evaluation Standards

A: 0.06 N/° C.·50 mm or more
B: 0.05 N/° C.·50 mm or more and less than 0.06 N/° C.·50 mm C: less than 0.05 N/° C.·50 mm

### 3. Evaluation Result

FIG. 3 illustrates the composition and the evaluation results of the aqueous adhesive composition used in each of the examples. It can be seen from FIG. 3 that since the aqueous adhesive composition on the surface of the fabric transport member of the ink jet textile printing apparatus includes the predetermined (meth)acrylic resin, the peelability of the adhesive layer formed at the fabric transport member is excellent, and the cleaning resistance, adhesive force, and dispersion stability are further improved.

What is claimed is:

1. An aqueous adhesive composition for forming an adhesive layer of a fabric transport member of an ink jet textile printing apparatus including a transport mechanism that bonds a fabric to the adhesive layer formed at a surface of the fabric transport member to transport the fabric, a heating portion that heats the adhesive layer, a bonding portion that bonds the fabric to the heated adhesive layer, a recording portion that attaches an ink composition to the fabric bonded to the adhesive layer using an ink jet head, a peeling portion that peels off the recorded fabric from the adhesive layer, and a cleaning portion that cleans the adhesive layer from which the fabric is peeled off with a cleaning solution containing water, the aqueous adhesive composition comprising:
a (meth)acrylic resin, wherein
when an adhesive force with which the fabric is peeled off from the adhesive layer cooled to 23° C. after bonding the fabric to the adhesive layer heated to 33° C. is represented by an adhesive force A (N/50 mm) and an adhesive force with which the fabric is peeled off from the adhesive layer at 23° C. after bonding the fabric to the adhesive layer at 23° C. is represented by an adhesive force B (N/50 mm), a change rate of adhesive force per unit temperature represented by (A−B)/(33° C.−23° C.) is 0.050 N/° C.·50 mm or more.

2. The aqueous adhesive composition according to claim 1, wherein
the adhesive force B is 0.5 to 2.0 N/50 mm.

3. The aqueous adhesive composition according to claim 1, wherein
a difference (G″23−G″33) between a loss elastic modulus G″23 at 23° C. and a loss elastic modulus G″33 at 33° C. is 3.0×10³ to 10×10³ Pa.

4. The aqueous adhesive composition according to claim 1, wherein
the (meth)acrylic resin includes a first (meth)acrylic resin including, as a constituent unit, a (meth)acrylic monomer where a glass transition temperature of a homopolymer is 40° C. or higher.

5. The aqueous adhesive composition according to claim 1, wherein
the (meth)acrylic resin includes a second (meth)acrylic resin having a higher glass transition temperature Tg2 than a glass transition temperature Tg1 of a first (meth)acrylic resin.

6. The aqueous adhesive composition according to claim 5, wherein
a content of the first (meth)acrylic resin is 53 to 82% by mass with respect to a total amount of the first (meth)acrylic resin and the second (meth)acrylic resin.

7. The aqueous adhesive composition according to claim 1, wherein
a total content of compounds selected from the group consisting of a rosin-based compound, a terpene-based compound, and a hydrocarbon resin is 5.0% by mass or less with respect to a total amount of the aqueous adhesive composition.

8. The aqueous adhesive composition according to claim 1, wherein
a content of an organic solvent is 5.0% by mass or less with respect to a total amount of the aqueous adhesive composition.

9. An adhesion imparting method comprising:
attaching the aqueous adhesive composition according to claim 1 to a surface of a fabric transport member of an ink jet textile printing apparatus to form an adhesive layer.

10. An ink jet textile printing apparatus comprising:
a transport mechanism that bonds a fabric to an adhesive layer of the aqueous adhesive composition according to claim 1 formed at a surface of a fabric transport member to transport the fabric;
a heating portion that heats the adhesive layer;
a bonding portion that bonds the fabric to the heated adhesive layer;
a recording portion that attaches an ink composition to the fabric bonded to the adhesive layer using an ink jet head;
a peeling portion that peels off the recorded fabric from the adhesive layer; and
a cleaning portion that cleans the adhesive layer from which the fabric is peeled off with a cleaning solution containing water.

11. A fabric transport member of an ink jet textile printing apparatus comprising:
an adhesive layer of the aqueous adhesive composition according to claim 1 on a surface.

12. An ink jet textile printing method comprising:
bonding a fabric to an adhesive layer of the aqueous adhesive composition according to claim 1 formed at a surface of a fabric transport member of an ink jet textile printing apparatus to transport the fabric;
heating the adhesive layer;
bonding the fabric to the heated adhesive layer;
attaching an ink composition to the fabric bonded to the adhesive layer using an ink jet head;
peeling off the recorded fabric from the adhesive layer; and
cleaning the adhesive layer from which the fabric is peeled off with a cleaning solution containing water.
